(19) United States
(12) Patent Application Publication
(10) Pub. No.: US 2026/0296486 A1
(43) Pub. Date: Oct. 1, 2026

(54) VEHICLE CONTROL DEVICE, VEHICLE CONTROL METHOD, AND NON-TRANSITORY STORAGE MEDIUM

(71) Applicant: HONDA MOTOR CO., LTD., Tokyo (JP)

(72) Inventors: Yuma Watanabe, Tokyo (JP); Takao Tamura, Tokyo (JP)

(21) Appl. No.: 19/543,894

(22) Filed: Feb. 19, 2026

(30) Foreign Application Priority Data
Mar. 28, 2025 (JP) 2025-056273

(51) Int. Cl. B60W 60/00

(52) U.S. Cl. CPC B60W 60/001; B60W 60/0013

(57) ABSTRACT

A vehicle control device includes a control unit that acquires positional information of a vehicle and executes vehicle control that is automated driving or driving assistance of the vehicle. There are a 1st area and a 2nd-area adjacent to the 1st area. The 2nd area is an area where the vehicle control that is suppliable is different from in the 1st area. The 1st area includes a 1st-1 area, a 1st-2 area, and a 1st-3 area. The control unit identifies whether the vehicle is located in one of the 1st-1, 1st-2, and 1st-3 areas based on the positional information. The vehicle control is not executed when the vehicle is located in the 1st-1 area. Start of the vehicle control is prohibited when the vehicle is located in the 1st-2 area. The vehicle control is executed when the vehicle is located in the 1st-3 area.

### CROSS-REFERENCE TO RELATED APPLICATION

Priority is claimed on Japanese Patent Application No. 2025-056273, filed Mar. 28, 2025, the content of which is incorporated herein by reference.

### BACKGROUND

### FIELD OF THE INVENTION

The present invention relates to a vehicle control device, a vehicle control method, and a non-transitory storage medium.

### DESCRIPTION OF RELATED ART

In recent years, measures have been actively taken to provide access to sustainable transportation systems in which people who are in vulnerable positions among traffic participants are taken into consideration. To achieve this goal, research and development have been focused on further improvement in traffic safety and convenience by research and development of driving assistance techniques for assisting driver's driving operations. For example, control devices capable of switching vehicle control according to each of plurality of areas in which different types of vehicle control are provided are known (Japanese Unexamined Patent Application, First Publication No. 2021-103408 and Japanese Unexamined Patent Application, First Publication No. 2021-128380).

### SUMMARY

Incidentally, in driving assistance devices of the related art, convenience for users is low in some cases. In the related art, when vehicles travel near boundaries, the vehicles may come and go between adjacent areas, and thus vehicle control is unnecessarily switched frequently. Thus, users may feel bothered, which leads to low convenience.

The present disclosure has been made in view of such circumstances and an object of the present disclosure is to provide a vehicle control device, a vehicle control method, and a non-transitory storage medium capable of improving convenience. More specifically, an object of the present disclosure is to implement vehicle control without causing a driver to feel bothered. Further, the present disclosure contributes to development of sustainable transportation systems.

A vehicle control device, a vehicle control method, and a non-transitory storage medium according to aspects of the present invention have the following configurations.
(1) According to one aspect of the present invention, there is provided a vehicle control device including: a storage medium storing computer-readable instructions; and one or more processors connected to the storage medium, the one or more processors executing the computer-readable instructions to: acquire positional information of a vehicle; and execute vehicle control, the vehicle control being automated driving or driving assistance of the vehicle, wherein there are a 1st area and a 2nd area adjacent to the 1st area, wherein the 2nd area is different the suppliable vehicle control from in the 1st area, wherein the 1st area includes a 1st-1 area, a 1st-2 area, and a 1st-3 area, wherein the 1st-1 area is an area adjacent to the 1st-2 area and a first boundary, the first boundary being a boundary line between the 1st and 2nd areas, wherein the 1st-2 area is an area adjacent to the 1st-1 and 1st-3 areas, wherein the 1st-3 area is an area adjacent to the 1st-2 area and not adjacent to the 1st-1 area and the boundary line, and wherein e one or more processors executing the computer-readable instructions to: identify whether the vehicle is located in one of the 1st-1, 1st-2, and 1st-3 areas based on the positional information; prevent the vehicle control when the vehicle is located in the 1st-1 area; prohibit start of the vehicle control when the vehicle is located in the 1st-2 area; and execute the vehicle control when the vehicle is located in the 1st-3 area.
(2) In the above aspect (1), the one or more processors execute the computer-readable instructions to: recognize surrounding information, the surrounding information being information regarding surroundings of the vehicle; change a range of an area by changing at least one of boundaries between the 1st-1, 1st-2, and 1st-3 areas based on the surrounding information.
(3) In the above aspect (1) or (2), the 1st-2 area may be an area adjacent to the 1st-1 area without overlapping, and the 1st-3 area may be an area adjacent to the 1st-2 area without overlapping. The one or more processors execute the computer-readable instructions to control execution, start, or continuation of the vehicle control in accordance with movement of a vehicle between areas.
(4) In the above aspect (1) or (2), a part of the 1st-1 area may overlap a part of the 1st-2 area, and a part of the 1st-2 area may overlap a part of the 1st-3 area. The one or more processors execute the computer-readable instructions to control execution, start, or continuation of the vehicle control in accordance with movement of a vehicle between areas.
(5) In the above aspect (4), the one or more processors execute the computer-readable instructions to: prevent the vehicle control by prioritizing a standard corresponding to the 1st-1 area when the vehicle is located in a first overlapping area, the first overlapping area being an area overlapping the 1st-1 and 1st-2 areas; and prohibit start of the vehicle control by prioritizing a standard corresponding to the 1st-2 area when the vehicle is located in a second overlapping area, the second overlapping area being an area overlapping the 1st-2 and 1st-3 areas.
(6) In the above aspect (4), the one or more processors execute the computer-readable instructions to execute the vehicle control by prioritizing a standard corresponding to an area located the vehicle before movement of the vehicle to the first or second overlapping area when the vehicle is located in a first overlapping area or a second overlapping area, the first overlapping area overlapping the 1st-1 and 1st-2 areas, the second overlapping area overlapping the 1st-2 and 1st-3 areas.
(7) In one of the above aspects (1) to (6), the one or more processors execute the computer-readable instructions to: acquire control information regarding the suppliable vehicle control in the first and second areas; and execute the vehicle control without imposing restriction on control of the vehicle control when control information of the first area is identical with control information of the second area and when the vehicle is located in the 1st-1, 1st-2, or 1st-3 area.
(8) According to another aspect of the present invention, a vehicle control method causes a computer to execute: acquiring positional information of a vehicle; and executing vehicle control, the vehicle control being automated driving or driving assistance of the vehicle, wherein there are a 1st area and a 2nd area adjacent to the 1st area, wherein the 2nd area is different the suppliable vehicle control from in the 1st area, wherein the 1st area includes a 1st-1 area, a 1st-2 area, and a 1st-3 area, wherein the 1st-1 area is an area adjacent to the 1st-2 area and a first boundary, the first boundary being a boundary line between the 1st and 2nd areas, wherein the 1st-2 area is an area adjacent to the 1st-1 and 1st-3 areas, wherein the 1st-3 area is an area adjacent to the 1st-2 area and not adjacent to the 1st-1 area and the boundary line, and wherein the vehicle control method causes a computer to execute: identifying whether the vehicle is located in one of the 1st-1, 1st-2, and 1st-3 areas based on the positional information; preventing the vehicle control when the vehicle is located in the 1st-1 area; prohibiting start of the vehicle control when the vehicle is located in the 1st-2 area; and executing the vehicle control when the vehicle is located in the 1st-3 area.
(9) According to one aspect of the present invention, there is provided a non-transitory storage medium having a program stored thereon that causes a computer to: acquire positional information of a vehicle; and execute vehicle control, the vehicle control being automated driving or driving assistance of the vehicle, wherein there are a 1st area and a 2nd area adjacent to the 1st area, wherein the 2nd area is different the suppliable vehicle control from in the 1st area, wherein the 1st area includes a 1st-1 area, a 1st-2 area, and a 1st-3 area, wherein the 1st-1 area is an area adjacent to the 1st-2 area and a first boundary, the first boundary being a boundary line between the 1st and 2nd areas, wherein the 1st-2 area is an area adjacent to the 1st-1 and 1st-3 areas, wherein the 1st-3 area is an area adjacent to the 1st-2 area and not adjacent to the 1st-1 area and the boundary line, and wherein the program causes the computer to: identify whether the vehicle is located in one of the 1st-1, 1st-2, and 1st-3 areas based on the positional information; prevent the vehicle control when the vehicle is located in the 1st-1 area; prohibit start of the vehicle control when the vehicle is located in the 1st-2 area; and execute the vehicle control when the vehicle is located in the 1st-3 area.

According to the aspects of (1) to (9), the vehicle control device, the vehicle control method, and the non-transitory storage medium can improve convenience by controlling execution, start, or continuation of the vehicle control in accordance with movement of a vehicle between areas.

According to the aspect of (2), the vehicle control device changes a shape of the area in accordance with a recognized surrounding environment or road geometry. Accordingly, it is possible to set a range of the area more flexibly in accordance with an actual surrounding environment or road geometry, or the like.

According to the aspect of (3), it is necessary for the vehicle control device to execute calculation for determining priority or the like when the areas overlap each other. It is not necessary to execute the calculation when the areas do not overlap each other. Accordingly, it is possible to implement vehicle control for reducing cost such as calculation cost.

According to the aspect of (4), the areas overlap each other in some cases due to a design reason. The vehicle control device can appropriately determine and switch whether to execute the vehicle control even when the areas overlap each other.

According to the aspect of (5), when the vehicle is located in an overlapping area, safer vehicle control can be executed by executing the vehicle control in accordance with a standard corresponding to an area where restriction is stricter.

According to the aspect of (6), when the vehicle is located in an overlapping area, restriction of start or continuation of excessive vehicle control can be inhibited by executing vehicle control in accordance with a standard corresponding to an area where the vehicle is located before movement to the overlapping area.

According to the aspect of (7), when the control information is identical between the first and second areas, convenience can be further improved by imposing no restriction on the vehicle control in each area included in the first area.

### BRIEF DESCRIPTION OF THE DRAWINGS

FIG. 1 is a diagram illustrating a configuration of a vehicle system using a vehicle control system according to an embodiment.

FIG. 2 is a diagram illustrating an example of supply control information.

FIG. 3 is a diagram illustrating each area.

FIG. 4 is a diagram illustrating restriction of vehicle control in each area.

FIG. 5 is a diagram illustrating an example of a vehicle moving between areas.

FIG. 6 is a flowchart illustrating an example of a flow of processing executed by a driving assistance device.

FIG. 7 is a flowchart illustrating a specific example of a subroutine in FIG. 6.

FIG. 8 is a flowchart illustrating a specific example of a subroutine in FIG. 6.

FIG. 9 is a flowchart illustrating a specific example of a subroutine in FIG. 6.

FIG. 10 is a diagram illustrating areas that overlap each other.

FIG. 11 is a flowchart illustrating an example of a flow of processing executed by the driving assistance device.

FIG. 12 is a flowchart illustrating an example of a flow of processing executed by the driving assistance device.

FIG. 13 is a flowchart illustrating a specific example of a subroutine in FIG. 12.

### DETAILED DESCRIPTION OF THE INVENTION

### Overall configuration

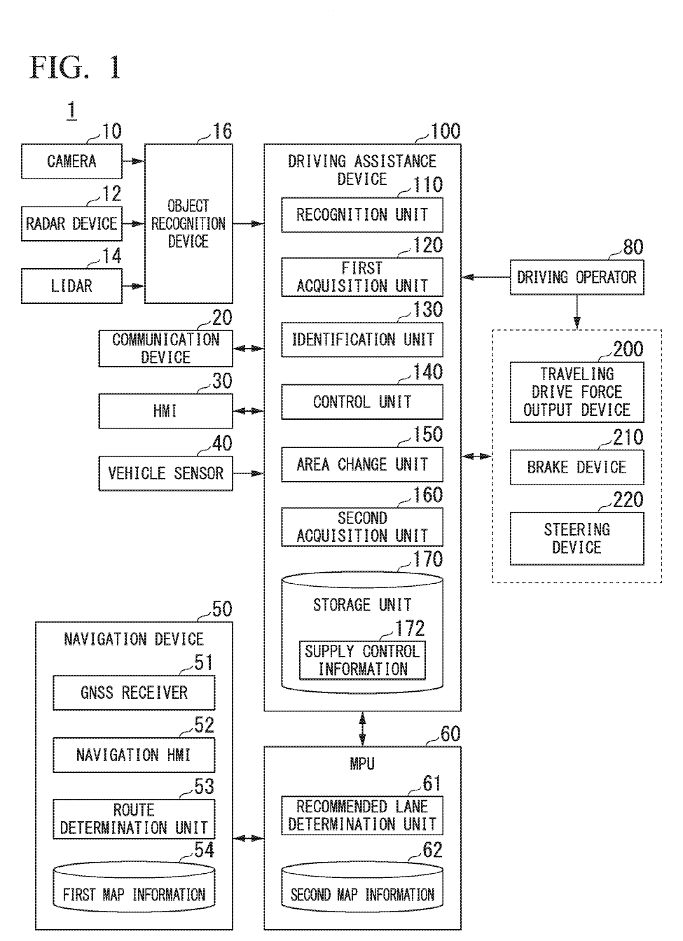

FIG. 1 is a diagram illustrating a configuration of a vehicle system 1 using a vehicle control system according to an embodiment. A vehicle in which the vehicle system 1 is mounted is, for example, a two-wheeled, three-wheeled, or four-wheeled vehicle. A drive source is an internal combustion engine such as a diesel engine or a gasoline engine, an electric motor, or a combination thereof. The electric motor operates using electric power generated by a generator connected to the internal combustion engine or power discharged from a second battery or a fuel cell.

The vehicle system 1 includes, for example, a camera 10, a radar device 12, a light detection and ranging (LIDAR) 14, an object recognition device 16, a microphone 18, a communication device 20, a human machine interface (HMI) 30, a vehicle sensor 40, a navigation device 50, an MPU 60, an operator 80, a driving assistance device 100, a traveling drive force output device 200, a brake device 210, and a steering device 220. These devices and instruments are connected to each other via a multiplex communication line such as a controller area network (CAN), a serial communication line, a wireless communication network, or the like. The configuration illustrated in FIG. 1 is merely exemplary, and a part of the configuration may be omitted, or another configuration may be added. The driving assistance device 100 is an example of a "vehicle control device."

The camera 10 is, for example, a digital camera using a solid-state image sensor such as a charge coupled device (CCD) or a complementary metal oxide semiconductor (CMOS). The camera 10 is mounted at any location of a vehicle in which the vehicle system 1 is mounted (hereinafter referred to as a vehicle M). When a front side is imaged, the camera 10 is mounted on an upper portion of a front windshield or on a rear surface of a room mirror. The camera 10 images the surroundings of the vehicle M, for example, periodically and repeatedly. The camera 10 may be a stereo camera.

The radar device 12 radiates radio waves such as millimeter waves to the surroundings of the vehicle M and detects radio waves reflected from an object (reflected waves) to detect at least a position (a distance and an azimuth) of the object. The radar device 12 is mounted at any location of the vehicle M. The radar device 12 may detect a position and a speed of an object in conformity with a frequency modulated continuous wave (FM-CW) scheme. The radar device 12 is mounted, for example, in a front corner (left or left) of the vehicle M. Accordingly, the radar device 12 can detect an object that is about to cross in front of the vehicle M.

The LIDAR 14 radiates light (or electromagnetic waves that have wavelengths close to the light) to the surroundings of the vehicle M and measures scattered light. The LIDAR 14 detects a distance to a target based on a time from light emission to light reception. The radiated light is, for example, pulsed laser light. The LIDAR 14 is mounted on any location of the vehicle M.

The object recognition device 16 executes sensor fusion processing on detection results obtained from some or all of the camera 10, the radar device 12, and the LIDAR 14 to recognize a position, type, speed, and the like of an object. The object recognition device 16 outputs a recognition result to the driving assistance device 100. The object recognition device 16 may output the detection results of the camera 10, the radar device 12, and the LIDAR 14 as they are to the driving assistance device 100. The object recognition device 16 may be omitted from the vehicle system 1.

The communication device 20 communicates with other vehicles located around the vehicle M using, for example, a cellular network, a Wi-Fi network, Bluetooth (registered trademark), a dedicated short range communication (DSRC), or the like or communicates with various server devices via wireless base stations.

The HMI 30 presents various types of information to an occupant of the vehicle M and accepts an input operation from the occupant. The HMI 30 includes various display devices, speakers, buzzers, touch panels, switches, and keys. The HMI 30 includes a display device. The display device is, for example, a display device that is provided in a middle portion of an instrument panel of the vehicle M and displays various types of information regarding the vehicle M, such as a speedometer indicating a traveling speed of the vehicle M or a tachometer indicating the engine speed (rotational speed) of an internal combustion engine included in the vehicle M, that is, a so-called multi-information display.

The vehicle sensor 40 includes a vehicle speed sensor that detects a speed of the vehicle M, an acceleration sensor that detects an acceleration, a yaw rate sensor that detects an angular velocity on a vertical axis, an azimuth sensor that detects a direction of the vehicle M, and a sensor that detects a steering rotation angle.

The navigation device 50 includes, for example, a global navigation satellite system (GNSS) receiver 51, a navigation HMI 52, and a route determination unit 53. The navigation device 50 retains first map information 54 in a storage device such as a hard disk drive (HDD) or a flash memory. The GNSS receiver 51 identifies a position of the vehicle M based on signals received from GNSS satellites. The position of the vehicle M may be identified or supplemented by an inertial navigation system (INS) using an output of the vehicle sensor 40. The navigation HMI 52 includes a display device, a speaker, a touch panel, and a key. The navigation HMI 52 may be shared partially or all with the above-described HMI 30. The route determination unit 53 determines a route from the position of the vehicle M identified by the GNSS receiver 51 (or any input position) to a destination input by an occupant using the navigation HMI 52 (hereinafter referred to as a map route) with reference to the first map information 54. The first map information 54 is, for example, information in which road geometries are represented by links indicating roads and nodes connected by the links. The first map information 54 may include road curvature or point of interest (POI) information. The map route is output to the MPU 60. The navigation device 50 may execute route guidance using the navigation HMI 52 based on the map route. The navigation device 50 may be implemented by, for example, a function of a terminal device such as a smartphone or a tablet terminal carried by an occupant. The navigation device 50 may transmit a current position and a destination to a navigation server via the communication device 20 and acquire a route equivalent to the map route from the navigation server.

The MPU 60 includes, for example, a recommended lane determination unit 61 and retains second map information 62 in a storage device such as an HDD or a flash memory. The recommended lane determination unit 61 divides a map route supplied from the navigation device 50 into a plurality of blocks (for example, divides the map route in a vehicle traveling direction every 100 [m]) and determines a recommended lane for each block with reference to the second map information 62. The recommended lane determination unit 61 determines in which lane counted from the left the vehicle M is traveling. The recommended lane determination unit 61 determines a recommended lane so that the vehicle M travels in a reasonable route for proceeding a branch destination when there is a branch point in the map route. For example, when the vehicle M reaches a predetermined distance before a branch road to be traveled, the recommended lane determination unit 61 determines a lane connected to the branch road as the recommended lane. The recommended lane determination unit 61 and the second map information 62 may serve as information or a functional unit included in another device such as the driving assistance device 100. For example, information regarding the recommended lane is supplied to a driver via the HMI.

The second map information 62 is map information that is more accurate than the first map information 54. The second map information 62 includes, for example, information regarding centers of lanes or information regarding boundaries of lanes. The second map information 62 may include road information, traffic regulation information, address information (addresses and portal numbers), facility information, and telephone number information. The second map information 62 may be updated as necessary through communication between the communication device 20 and another device.

The operator 80 includes, for example, a steering wheel, an accelerator pedal, a brake pedal, a shift lever, and other operators. A sensor that detects an operation amount or whether an operation is executed is attached to the operator 80, and some or all of detection results are output to the driving assistance device 100 or the traveling drive force output device 200, the brake device 210, and the steering device 220. The steering wheel may not be annular and may be in the form of a deformed steering wheel, a joystick, a button, or the like.

The driving assistance device 100 includes, for example, a recognition unit 110, a first acquisition unit 120, an identification unit 130, a control unit 140, an area change unit 150, a second acquisition unit 160, and a storage unit 170. The recognition unit 110, the first acquisition unit 120, the identification unit 130, the control unit 140, the area change unit 150, and the second acquisition unit 160 are implemented by, for example, a hardware processor such as a central processing unit (CPU) executing a program (software). Some or all of the constituent components may be implemented by hardware (a hardware unit including circuitry) such as a large scale integration (LSI), an application specific integrated circuit (ASIC), a field-programmable gate array (FPGA), a graphic processing unit (GPU), or a system on chip (SOC), or by cooperation of software and hardware. The program may be stored in advance in a storage unit (a storage device including a non-transitory storage medium) such as an HDD or a flash memory of the driving assistance device 100 or may be stored in a detachable storage medium such as a DVD or a CD-ROM and installed in the HDD or the flash memory of the driving assistance device 100 when the storage medium (non-transitory storage medium) is mounted in a drive device. A functional configuration including the control unit 140 or the identification unit 130 and the control unit 140 is an example of a "control unit."

The storage unit 170 may be implemented by any of the above various storage devices or by an electrically erasable programmable read only memory (EEPROM), a read only memory (ROM), a random access memory (RAM), or the like. The storage unit 170 stores, for example, supply control information 172, or various types of information, programs, and the like in the embodiment. The storage unit 170 may also store various types of setting information used for processing in the embodiment.

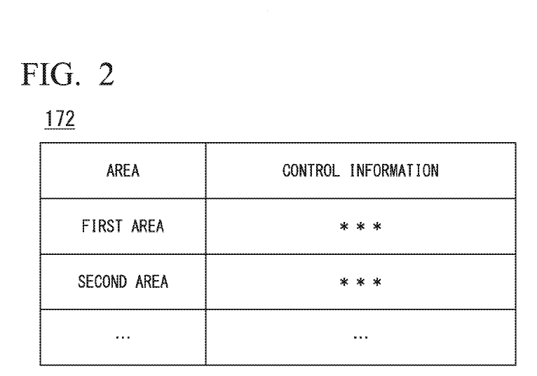

FIG. 2 is a diagram illustrating an example of the supply control information 172. The supply control information 172 includes control information that is information regarding suppliable vehicle control. The vehicle control is executed by a control unit 140 to be described below and is automated driving or driving assistance of the vehicle M. The control information may be, for example, a condition when the driving assistance device 100 can execute vehicle control of the vehicle M based on a traffic law of each area or may be information based on use restriction of the vehicle control in each area. The control information may be, for example, information indicating whether the vehicle control can be executed. The supply control information 172 is stored such that each area is associated with the control information. Here, information stored in the supply control information 172 is not limited thereto. The supply control information 172 may be acquired from an external device via the communication device 20. The supply control information 172 may be updated to latest information at a predetermined timing or cycle.

The recognition unit 110 recognizes a position of an object around the vehicle M and states such as a speed and an acceleration based on surrounding information input from the camera 10, the radar device 12, and the LIDAR 14 via the object recognition device 16. The position of the object is recognized, for example, as a position on an absolute coordinate system that has a representative point of the vehicle M (the center of gravity, the center of a drive axis, or the like) as the origin and is used for control. The position of the object may be represented as a representative point of the object such as the center of gravity or a corner of the object or may be represented as an area. The "states" of the object may include an acceleration or a jerk of the object or a "behavioral state" (for example, whether a change in lane is executed or attempted).

The recognition unit 110 recognizes, for example, a track of the vehicle M, a track located in the surroundings of the track, or the like. The track is a route on a road that includes a lane in which the vehicle M is traveling (traveling lane) and an oncoming lane. For example, the recognition unit 110 recognizes a track by comparing a pattern of road lane markings (for example, an arrangement of solid lines and broken lines) obtained from the second map information 62 with a pattern of road lane markings around the vehicle M recognized from images captured by the camera 10. The recognition unit 110 may recognize a track by recognizing track boundaries (road boundaries) including not only road lane markings but also road line markings, road shoulders, curbs, medians, and guardrails. In this recognition, a position of the vehicle M acquired from the navigation device 50 or a processing result obtained by an INS may also be added. The recognition unit 110 recognizes stop lines, obstacles, read traffic signals, toll gates, and other road events that are around the vehicle M.

The recognition unit 110 recognizes a behavior of the vehicle M based on a detection result of the vehicle sensor 40. For example, the recognition unit 110 recognizes a position and an orientation of the vehicle M with respect to a track when the track is recognized. The recognition unit 110 may recognize, as a relative position and an orientation of the vehicle M with respect to the track, a deviation of a standard point of the vehicle M from the center of a line and an angle formed with a line connecting the center of a lane in a traveling direction of the vehicle M. Alternatively, the recognition unit 110 may recognize a position of the standard point of the vehicle M relative to one side edge (a road lane marking or a road boundary) of the track as a relative position of the vehicle M with respect to the track.

The first acquisition unit 120 acquires positional information of the vehicle M. The first acquisition unit 120 may acquire, for example, a position of the vehicle M identified by the GNSS receiver 51 as the positional information of the vehicle M. The positional information may be information indicating a position at which the vehicle M is located (for example, latitude and longitude).

The identification unit 130 identifies whether the vehicle M is located in one of 1st-1, 1st-2, and 1st-3 areas based on the positional information. Specifically, the identification unit 130 identifies whether the position of the vehicle M identified based on the positional information is included in one of the 1st-1, 1st-2, and 1st-3 areas. Information (latitude and longitude, or the like) for identifying positions of the 1st-1, 1st-2, and 1st-3 areas is stored in the storage unit 170.

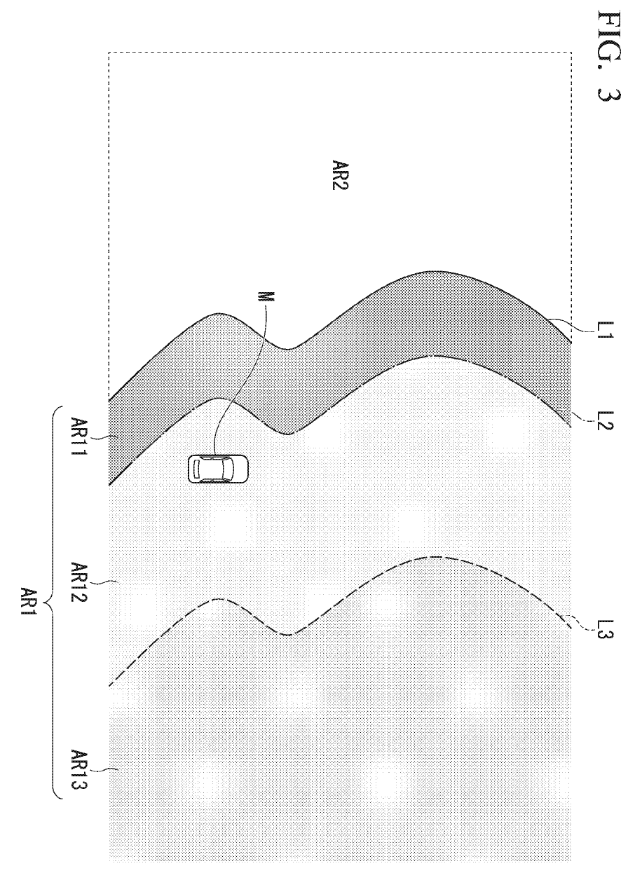

FIG. 3 is a diagram illustrating each area. In FIG. 3, a first area AR1 and a second area AR2 are illustrated. The first area AR1 is an area where the vehicle M is traveling. The second area AR2 is an area adjacent to the first area AR1. The first area AR1 includes a 1st-1 area AR11, a 1st-2 area AR12, and a 1st-3 area AR13. The 1st-1 area AR11 is an area adjacent to the second area AR2 and the 1st-2 area AR12. The 1st-2 area AR12 is an area adjacent to the 1st-1 area AR11 and the 1st-3 area AR13. The 1st-2 area AR12 does not overlap the 1st-1 area AR11. The 1st-3 area AR13 is an area adjacent to the 1st-2 area AR12 and not adjacent to the 1st-1 area AR11 and the second area AR2. The 1st-3 area AR13 does not overlap the 1st-2 area AR12. A boundary line between the first area AR1 (1st-1 area AR11) and the second area AR2 is referred to as a first boundary L1, a boundary line between the 1st-1 area AR11 and the 1-2 area AR12 is referred to as a second boundary L2, and a boundary line between the 1st-2 area AR12 and the 1-3 area AR13 is referred to as a third boundary L3. The first boundary L1 may be, for example, a national border, may be a prefectural border, or may be a boundary line between a communicable range and a non-communicable range. The first boundary L1 may be a standard by which a contiguous land is divided into two areas. The second boundary L2 may be determined based on the first boundary, and the third boundary L3 may be determined based on the second boundary L2. Positions, shapes, and the like of the second boundary L2 and the third boundary L3 may be set, for example, so that a distance from a boundary serving as a standard becomes a predetermined distance or a distance that requires a predetermined time at a traveling speed of the vehicle M from a boundary serving as a standard. In this case, the positions, shapes, and the like of the second boundary L2 and the third boundary L3 are changed in accordance with a traveling speed of the vehicle M.

The control unit 140 controls the entire configurations of the driving assistance device 100 and the vehicle system 1. The control unit 140 controls, for example, the HMI 30 and supplies information to a driver. The control unit 140 executes vehicle control that is automated driving or driving assistance of the vehicle M based on surrounding information of the vehicle M recognized by the recognition unit 110.

The driving assistance includes, for example, adaptive cruise control system (ACC) or a lane keeping assistance system (LKAS). When the ACC is executed, the control unit 140 executes control based on the surrounding information such that the vehicle M travels while maintaining a constant distance from another vehicle traveling in front. That is, the control unit 140 executes control such that the vehicle M travels at a speed corresponding to a speed of another vehicle traveling in front. For example, when another vehicle traveling in front accelerates, the control unit 140 executes control such that the vehicle M accelerates. When another vehicle traveling in front decelerates, the control unit 140 executes control such that the vehicle M decelerates. When there is no vehicle traveling in front, the control unit 140 may execute control such that the vehicle M travels while maintaining any set speed. When the LKAS is executed, the control unit 140 executes control such that the vehicle M travels at or near the center of a lane based on a lane recognized by the recognition unit 110. For example, when the vehicle M travels in a direction in which lane departure occurs, the control unit 140 may execute control such that the vehicle M becomes closer to the center of the lane or near the center of the lane by assisting a steering operation. The driving assistance includes control for stopping the vehicle M based on the surrounding information. For example, when a stop lien, a read traffic, or a stopped vehicle in front is recognized, the control unit 140 may execute control such that the vehicle M stops safely. For example, the control unit 140 stops the vehicle M in front of a stop line, at the stop line corresponding to the red signal, near the stop line, or the like. For example, the control unit 140 stops the vehicle M at a predetermined distance before a stopped vehicle in front.

In the automated driving, the control unit 140 generates a target trajectory such that the vehicle M does not pass through a point at which a risk is a predetermined value or more and travels in a recognized track or traveling lane, or the like. For example, the target trajectory is expressed by arranging points at which the vehicle M arrives (trajectory points) in order. The trajectory points are points at which the vehicle M arrives at each predetermined traveling distance (for example, about several meters) along a road. Apart from this, a target speed and a target acceleration are generated as part of the target trajectory at a predetermined sampling time (for example, about fractions of a second). The trajectory point may be a position at which the vehicle M arrives at a sampling time at each predetermined sampling time. In this case, information regarding the target speed or the target acceleration is expressed at intervals of trajectory points. The control unit 140 controls the vehicle M such that the vehicle M travels along the target trajectory. For example, when the vehicle M approaches an intersection, the control unit 140 generates a target trajectory for turning right and entering a crossing road to move forward a destination. The control unit 140 controls the vehicle M such that the vehicle M travels along the generated trajectory. Details of processing of the identification unit 130 and the control unit 140 will be described below.

The area change unit 150 changes the range of the area by changing a boundary of at least one of the boundaries between the 1st-1 area AR11, the 1st-2 area AR12, and the 1st-3 area AR13. That is, the area change unit 150 changes a range of an area of some or all of the 1st-1 area AR11, the 1st-2 area AR12, and the 1st-3 area AR13 by changing the boundary of at least one of the second boundary L2 and the third boundary L3. For example, the area change unit 150 may change the second boundary L2 and/or the third boundary L3 in accordance with a surrounding road geometry or may change the second boundary L2 and/or the third boundary L3 in accordance with a surrounding environment. The surrounding environment is, for example, information regarding feature points of an object around the vehicle M recognized by the recognition unit 110, a radio wave situation, and the like. For example, in the case of an environment in which it is predicted that safe vehicle control cannot be executed, such as a case where feature points of a surrounding object are not acquired, a case where a radio wave situation is poor and positional information cannot be acquired, or a case where the first map information 54 or the second map information 62 malfunctions, the area change unit 150 may strengthen the vehicle control restriction to be described below by changing the second boundary L2 and/or the third boundary L3 and changing a range of the area. For example, when the vehicle M is traveling in the range of the 1st-2 area AR12 and safe vehicle control cannot be executed, the area change unit 150 may prohibit the vehicle control through vehicle control in accordance with an area where the vehicle M is located, as will be described, by moving the second boundary L2 and setting a range in which the vehicle M is traveling as the 1st-1 area AR11. The area change unit 150 changes the range of the area by moving the second boundary L2 or the third boundary L3 to one left or right track boundary, for example, when the second boundary L2 or the third boundary L3 matches a traveling lane. The area change unit 150 may change the range of the area by moving the second boundary L2 so that the second boundary L2 does not cross a road when the road is a road of a route in which the vehicle moves back and forth between the 1st-1 area AR1 and the 1st-2 area AR2. Accordingly, since the vehicle M can be prevented from being located on a boundary line, vehicle control can be appropriately executed in accordance with an area where the vehicle M is located, as described below.

The second acquisition unit 160 acquires control information. The second acquisition unit 160 may acquire control information associated with each area with referenced to the supply control information 172. The second acquisition unit 160 acquires control information associated with each of at least first and second areas.

The traveling drive force output device 200 outputs a traveling drive force (torque) for traveling the vehicle M to a drive wheel. The traveling drive force output device 200 includes, for example, a combination of an internal combustion engine, an electric motor, and a transmission, and an ECC controlling these components. The ECU controls the above configuration in accordance with information input from the driving assistance device 100 or information input from the operator 80.

The brake device 210 includes, for example, a brake caliper, a cylinder that transmits hydraulic pressure to the brake caliper, an electric motor that generates a hydraulic pressure in the cylinder, and a brake ECU. The brake ECU controls the electric motor in accordance with information input from the driving assistance device 100 or information input from the operator 80 such that a brake torque corresponding to a braking operation is output to each wheel.

The steering device 220 includes, for example, a steering ECU and an electric motor. The electric motor changes a direction of a steered wheel by applying a force to a rack-and-pinion mechanism. The electric ECU drives the electric motor and changes a direction of the steered wheel in accordance with information input from the driving assistance device 100 or information input from the operator 80.

### Details of processing

In the embodiment, the control unit 140 identifies whether the vehicle is located in one of the 1st-1, 1st-2, and 1st-3 areas based on positional information and executes vehicle control based on a standard corresponding to an identified area.

The standard corresponding to the area is the following three items:
(1) the control unit 140 does not execute (prevent) the vehicle control when the vehicle M is located in the 1st-1 area AR11;
(2) the control unit 140 prohibits start of the vehicle control when the vehicle M is located in the 1st-2 area AR12; and
(3) the control unit 140 executes the vehicle control when the vehicle M is located in the 1st-3 area AR13.

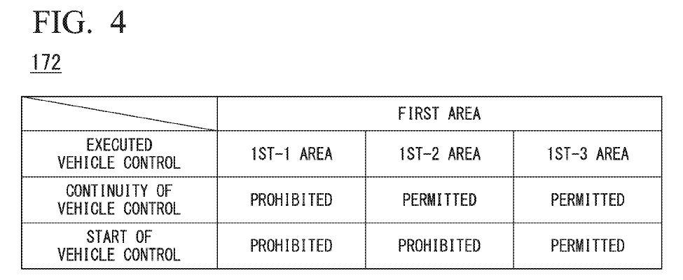

Content of (1) to (3) will be described specifically. FIG. 4 is a diagram illustrating restriction of vehicle control in each area. Information illustrated in FIG. 4 may be part of the supply control information 172. For example, predetermined vehicle control (for example, automated driving or predetermined driving assistance) in the first area is permitted to be executed and the predetermined vehicle control in the second area is prohibited. In FIG. 4, when the vehicle M is located in each area, whether each vehicle control is permitted is illustrated. "Continuity of vehicle control" indicates whether to continuously execute the vehicle control when the vehicle control has already been executed. "Start of vehicle control" indicates whether to execute the vehicle control when new vehicle control is obtained in a state where the vehicle control is not executed. When the vehicle M is located in the 1st-1 area AR11, "Continuity of vehicle control" and "Start of vehicle control" are prohibited. When the vehicle M is located in the 1st-2 area AR12, "Continuity of vehicle control" is permitted and "Start of vehicle control" is prohibited. When the vehicle M is located in the 1st-3 area AR13, "Continuity of vehicle control" and "Start of vehicle control" are permitted. As illustrated in FIG. 4, the farther an area is from the first boundary L1, the fewer restriction of the vehicle control is. That is, the restriction of the vehicle control is less in the 1st-2 area AR12 than in the 1st-1 area AR11, and the restriction of the vehicle control is less in the 1st-3 area AR13 than in the 1st-2 area AR12.

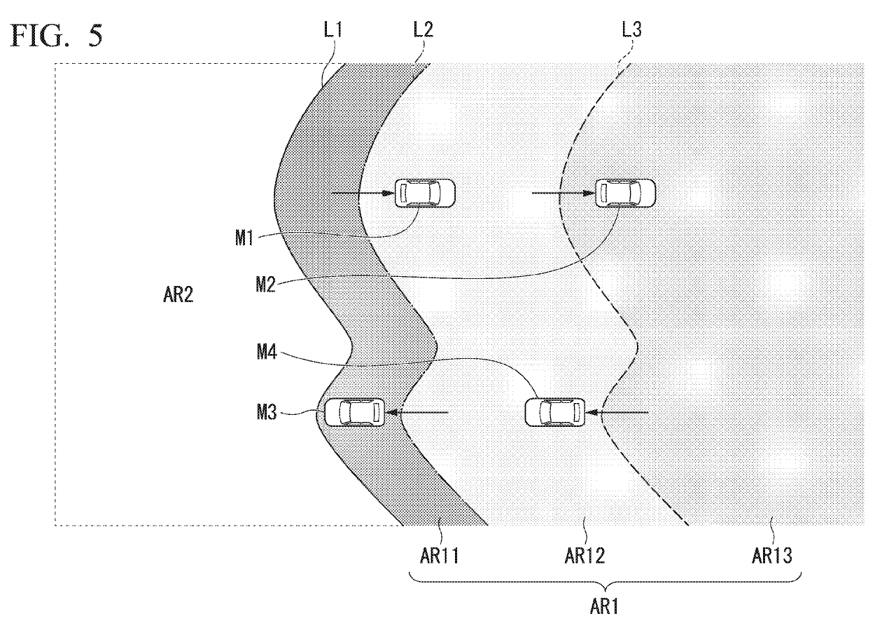

FIG. 5 is a diagram illustrating an example of the vehicle M moving between areas. The control unit 140 controls execution, start, or continuity of the vehicle control in accordance with movement of the vehicle M between the areas. FIG. 5 illustrates vehicles M1 to M4 moving between the areas.

The vehicle M1 is a vehicle moving from the 1st-1 area AR11 to the 1st-2 area AR12. "Continuity of vehicle control" and "Start of vehicle control" in the 1st-1 area AR11 are prohibited. Therefore, the vehicle control is not executed even when the vehicle M1 is moved to the 1st-2 area AR12. "Start of vehicle control" in the 1st-2 area AR12 is prohibited. Therefore, the control unit 140 does not execute (prevent) the vehicle control even when the driver requests the vehicle control after movement of the vehicle M1 to the 1st-2 area AR12.

The vehicle M2 is a vehicle moving from the 1st-2 area AR12 to the 1st-3 area AR13. When the vehicle control is executed during the vehicle M2 located in the 1st-2 area AR12, "Continuity of vehicle control" is permitted in the 1st-3 area AR13. Therefore, the control unit 140 continues the vehicle control even after the vehicle M2 is moved to the 1st-3 area AR13. When the vehicle control is not executed during the vehicle M2 located in the 1st-2 area AR12, "Start of vehicle control" is permitted in the 1st-3 area AR13. Therefore, when the driver requests the vehicle control after movement of the vehicle M2 to the 1st-3 area AR13, the control unit 140 executes the vehicle control.

The vehicle M3 is a vehicle moving from the 1st-2 area AR12 to the 1st-1 area AR11. When the vehicle control is executed during the vehicle M3 located in the 1st-2 area AR12, "Continuity of vehicle control" is prohibited in the 1st-1 area AR11. Therefore, the control unit 140 ends the vehicle control even when the vehicle M3 is moved to the 1st-1 area AR11. When the vehicle control is not executed during the vehicle M3 located in the 1st-2 area AR12, "Start of vehicle control" is prohibited in the 1st-1 area AR11. Therefore, when the driver requests the vehicle control after movement of the vehicle M3 to the 1st-1 area AR11, the control unit 140 does not execute the vehicle control.

The vehicle M4 is a vehicle moving from the 1st-3 area AR13 to the 1st-2 area AR12. When the vehicle control is executed during the vehicle M4 located in the 1st-3 area AR13, "Continuity of vehicle control" is permitted in the 1st-2 area AR12. Therefore, the control unit 140 continues the vehicle control even after the vehicle M4 is moved to the 1st-2 area AR12. When the vehicle control is not executed during the vehicle M4 located in the 1st-3 area AR13, "Start of vehicle control" is prohibited in the 1st-2 area AR12. Therefore, when the driver requests the vehicle control after movement of the vehicle M4 to the 1st-2 area AR12, the control unit 140 does not execute the vehicle control.

Here, a device is assumed in which the vehicle control is executed in an area that is at least a predetermined distance away from the first boundary L1, and the vehicle control is not executed in an area that is within the predetermined distance from the first boundary L1. In such a device, for example, the vehicle control ends when the vehicle moves to the 1st-1 area AR11 in a case where the vehicle is traveling in a track (a track near the second boundary L2) moving back and forth between the 1st-1 area AR11 and the 1st-2 area AR12, the vehicle control starts when the vehicle moves to the 1st-2 area AR12. Thus, the execution and end of the vehicle control are repeated frequently, and thus there is concern of the driver feeling troublesome. In the embodiment, as described above, by executing the vehicle control based on an area where the vehicle M is located, the vehicle control is executed appropriately at a timing, which can improve convenience. Specifically, for example, when the vehicle is traveling in a track (a track near the second boundary L2) in which the vehicle moves back and forth between the 1st-1 area AR11 and the 1st-2 area AR12 several times, start of the vehicle control in the 1st-2 area AR2 is prohibited. Thus, after the vehicle control ends, the start of the vehicle control is not started again. That is, the execution and end of the vehicle control are repeated frequently, and thus there is concern of the driver feeling troublesome.

### First processing flow

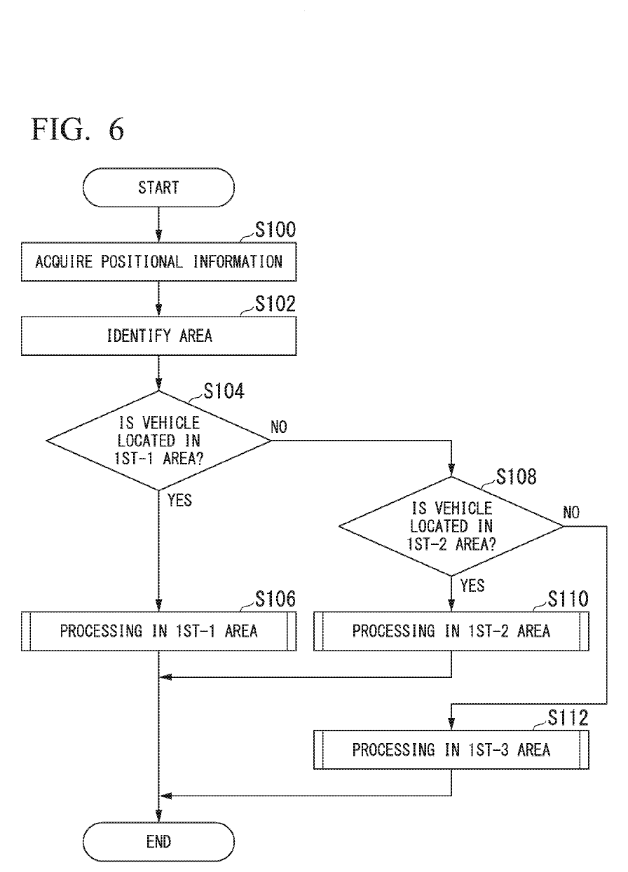

FIG. 6 is a flowchart illustrating an example of a flow of processing executed by the driving assistance device 100. The processing in the flowchart illustrated in FIG. 6 is executed, for example, during traveling of the vehicle M.

First, the first acquisition unit 120 acquires positional information of the vehicle M (step S100). Subsequently, the identification unit 130 identifies an area where the vehicle M is located (step S102). Specifically, based on the positional information, the identification unit 130 identifies whether the vehicle M is located in one of the 1st-1 area AR11, the 1st-2 area AR12, and the 1st-3 area AR13. Subsequently, the control unit 140 determines whether the vehicle M is located in the 1st-1 area AR11 (step S104). When the vehicle M is located in the 1st-1 area AR11 (YES in step S104), the processing proceeds to step S106. Content of the processing of step S106 will be described below. In step S106, the driving assistance device 100 executes the processing in the 1st-1 area AR11. When the vehicle M is not located in the 1st-1 area AR11 (NO in step S104), the control unit 140 determines whether the vehicle M is located in the 1st-2 area AR12 (step S108). When the vehicle M is located in the 1st-2 area AR12 (YES n step S108), the processing proceeds to step S110. Content of the processing of step S110 will be described below. In step S110, the driving assistance device 100 executes the processing in the 1st-2 area AR12. When the vehicle M is not located in the 1st-2 area AR12 (NO in step S108), the processing proceeds to step S112. Content of the processing of step S112 will be described below. In step S112, the driving assistance device 100 executes the processing in the 1st-3 area AR13. After processing of step S106, step S110, or step S112 ends, the driving assistance device 100 ends the processing illustrated in FIG. 6.

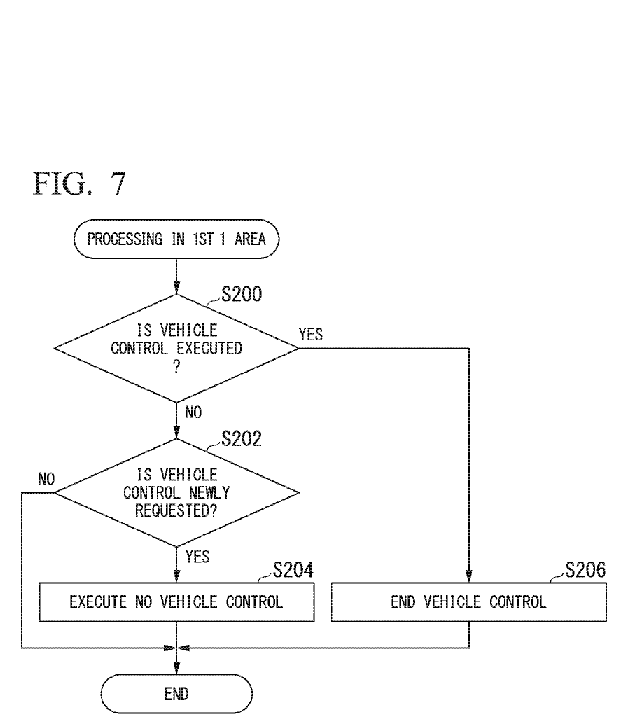

FIG. 7 is a flowchart illustrating a specific example of a subroutine in FIG. 6. Specifically, FIG. 7 is a flowchart illustrating a specific example of the processing of step S106.

First, the control unit 140 determines whether the vehicle control is executed (step S200). When the vehicle control is not executed (NO in step S200), it is determined whether the vehicle control is newly requested (step S202). When the vehicle control is newly requested (YES in step S202), the control unit 140 does not execute the vehicle control without responding to the request (step S204). When the vehicle control is executed (YES in step S200), the control unit 140 ends the vehicle control (step S206). After the processing of step S204 ends, after the processing of step S206 ends, or when the vehicle control is not newly requested (NO in step S202), the driving assistance device 100 ends the processing illustrated in FIG. 7.

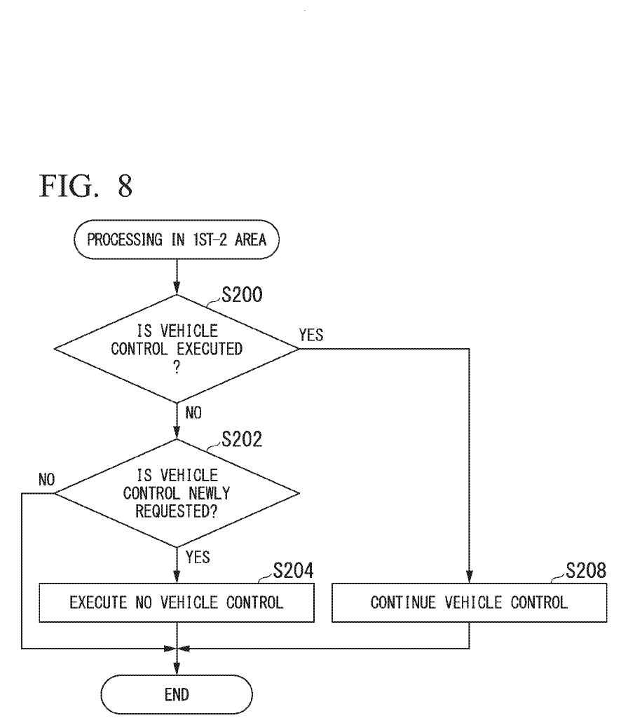

FIG. 8 is a flowchart illustrating a specific example of a subroutine in FIG. 6. Specifically, FIG. 8 is a flowchart illustrating a specific example of the processing of step S110.

The processing of steps S200 to S204 is similar to the processing illustrated in the flowchart of FIG. 7 described above. Differences from the flowchart of FIG. 7 will be described.

When the vehicle control is executed (YES in step S200), the control unit 140 continues the vehicle control (step S208). After the processing of step S204 ends, after the processing of step S208 ends, or when the vehicle control is not newly requested (NO in step S202), the driving assistance device 100 ends the processing illustrated in FIG. 8.

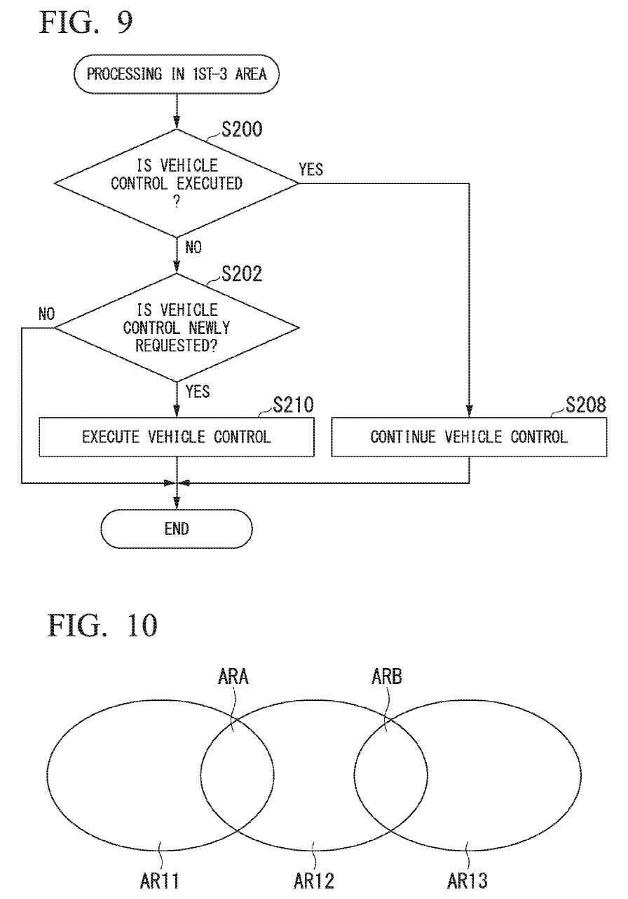

FIG. 9 is a flowchart illustrating a specific example of a subroutine in FIG. 6. Specifically, FIG. 9 is a flowchart illustrating a specific example of the processing of step S112.

The processing of step S200, S202, and S208 is similar to the processing illustrated in FIGS. 7 and 8 described above. Difference from the flowcharts of FIGS. 7 and 8 will be described.

When the vehicle control is newly requested (YES in step S202), the control unit 140 executes the vehicle control (step S210). After the processing of step S210 ends, after the processing of step S208 ends, or when the vehicle control is not newly requested (NO in step S202), the driving assistance device 100 ends the processing illustrated in FIG. 8.

In this way, by executing the vehicle control in accordance with the area where the vehicle M is located, the control unit 140 can execute the vehicle control without causing the driver to feel troublesome.

### Processing when areas overlap each other

The 1st-1 area AR11, the 1st-2 area AR12, and the 1st-3 area AR13 are set as the areas overlapping each other, as described above. However, the areas may be set such that a part of the 1st-1 area AR11 overlaps a part of the 1st-2 area AR12 and a part of the 1st-2 area AR12 overlaps a part of the 1st-3 area AR13.

FIG. 10 is a diagram illustrating areas that overlap each other. An area in which a part of the 1st-1 area AR11 overlaps a part of the 1st-2 area AR12 is referred to as a first overlap area ARA. An area in which a part of the 1st-2 area AR12 overlaps a part of the 1st-3 area AR13 is referred to as a second overlap area ARB.

### Second processing flow

When the vehicle M is located in the first overlap area ARA and the second overlap area ARB, the control unit 140 may control the vehicle control by prioritizing a standard corresponding to an area where there are many restrictions among the areas that overlap each other. For example, when the vehicle M is located in the first overlap area ARA, the control unit 140 may not execute the vehicle control by prioritizing a standard corresponding to the 1st-1 area AR11. For example, when the vehicle M is located in the second overlap area ARB, the control unit 140 may not execute the vehicle control by prioritizing a standard corresponding to the 1st-2 area AR12.

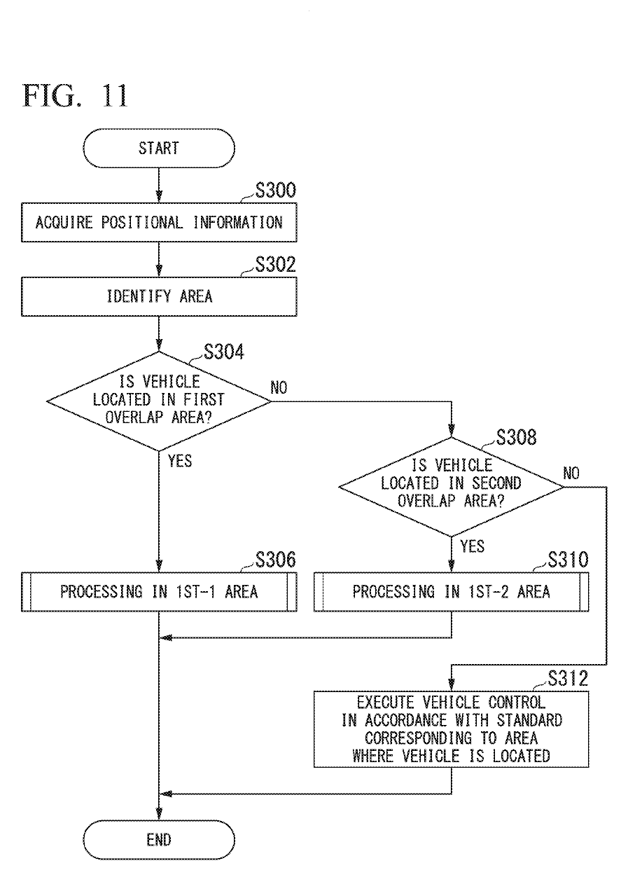

FIG. 11 is a flowchart illustrating an example of a flow of processing executed by the driving assistance device 100. The processing in the flowchart illustrated in FIG. 11 is executed while the vehicle M is traveling, for example, instead of the flowchart illustrated in FIG. 6.

First, the first acquisition unit 120 acquires the positional information of the vehicle M (step S300). Subsequently, the identification unit 130 identifies an area where the vehicle M is located (step S302). Subsequently, the control unit 140 determines whether the vehicle M is located in the first overlap area ARA (step S304). When the vehicle M is located in the first overlap area ARA (YES in step S304), the processing proceeds to step S306. The processing of step S306 is processing in the 1st-1 area AR11 similar to the processing described in FIG. 7.

When the vehicle M is not located in the first overlap area ARA (NO in step S304), the control unit 140 determines whether the vehicle M is located in the second overlap area ARB (step S308). When the vehicle M is located in the second overlap area ARB (YES in step S308), the processing proceeds to step S310. The processing of step S310 is processing in the 1st-2 area AR12 similar to the processing described in FIG. 8.

When the vehicle M is not located in the second overlap area ARB (NO in step S308), the control unit 140 controls the vehicle control in accordance with the standard corresponding to the area where the vehicle M is located (step S312). After the processing of step S306 ends, after the processing of step S310 ends, or after the processing of step S312 ends, the driving assistance device 100 ends the processing illustrated in FIG. 11.

In this way, when the vehicle M is located in the first overlap area ARA or the second overlap area ARB, the vehicle control can be executed (continue) more safely by executing the vehicle control by prioritizing the standard corresponding to the area where there are many (strong) restrictions among the areas that overlap.

Third processing flow

When the vehicle M is located in the first overlap area ARA or the second overlap area ARB, the control unit 140 may control the vehicle control by prioritizing a standard corresponding to the area where the vehicle M is located before movement to the first overlap area ARA or the second overlap area ARB. For example, when the vehicle M moves from the 1st-1 area AR11 to the second overlap area ARB, the control unit 140 may not execute the vehicle control by prioritizing the standard corresponding to the 1st-1 area AR11. For example, when the vehicle M moves from the 1st-2 area AR12 to the first overlap area ARA or the second overlap area ARB, the control unit 140 may prohibit start of the vehicle control by prioritizing a standard corresponding to the 1st-2 area AR12. For example, when the vehicle M moves from the 1st-3 area AR13 to the second overlap area ARB, the control unit 140 may execute the vehicle control by prioritizing a standard corresponding to the 1st-3 area AR13. At this time, the identification unit 130 currently identifies an area where the vehicle M is located before movement to the first overlap area ARA or the second overlap area ARB in addition to the area where the vehicle M is located. For example, when the area where the vehicle M is located is changed, the identification unit 130 may store an area where the vehicle M is located before the change in the storage unit 170. Based on the stored area where the vehicle M is located before the change, the identification unit 130 may identify an area where the vehicle M is located before movement to the first overlap area ARA or the second overlap area ARB. For example, a past movement route of the vehicle M based on the positional information is stored in the storage unit 170, and the identification unit 130 may identify the area where the vehicle M is located before the movement to the first overlap area ARA or the second overlap area ARB with reference to the past movement route.

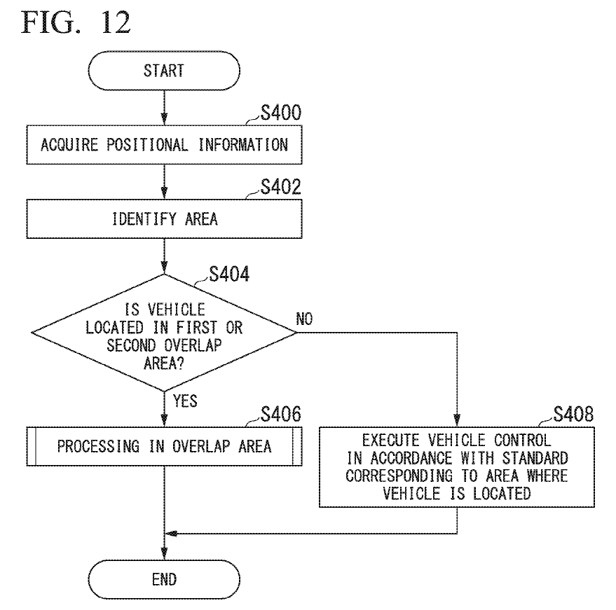

FIG. 12 is a flowchart illustrating an example of a flow of processing executed by the driving assistance device 100. The processing in the flowchart illustrated in FIG. 12 is executed while the vehicle M is traveling, for example, instead of the flowchart illustrated in FIG. 6 or 11.

First, the first acquisition unit 120 acquires the positional information of the vehicle M (step S400). Subsequently, the identification unit 130 identifies an area where the vehicle M is located (step S402). Subsequently, the control unit 140 determines whether the vehicle M is located in the first overlap area ARA or the second overlap area ARB (step S404). When the vehicle M is located in the first overlap area ARA or the second overlap area ARB (YES in step S404), the processing proceeds to step S406. Content of the processing of step S406 will be described below. In step S406, the driving assistance device 100 executes processing in the overlap area. When the vehicle M is not located in the first overlap area ARA or the second overlap area ARB (NO in step S404), the control unit 140 controls the vehicle control in accordance with a standard corresponding to the area where the vehicle M is located (step S408). After the processing of step S406 ends or after the processing of step S308 ends, the driving assistance device 100 ends the processing illustrated in FIG. 12.

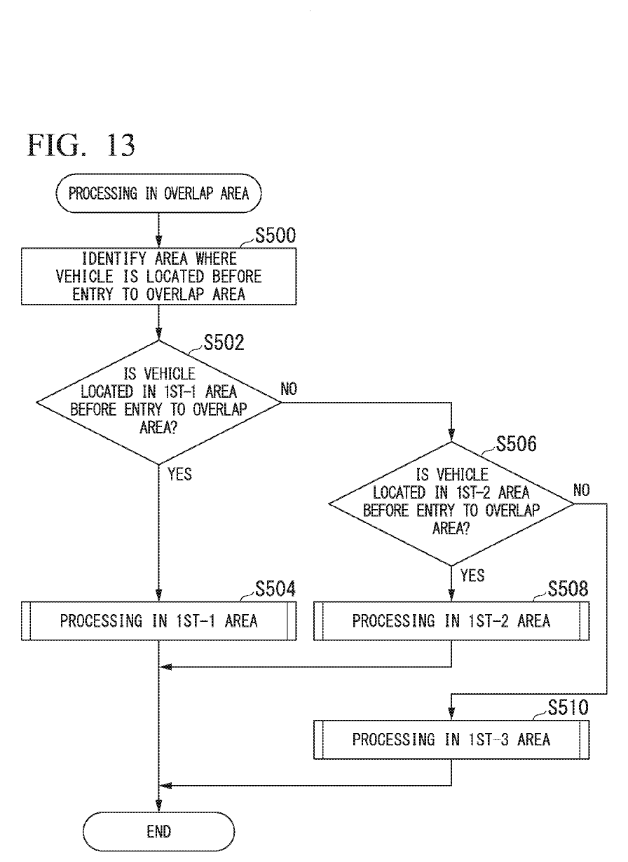

FIG. 13 is a flowchart illustrating a specific example of a subroutine in FIG. 12. Specifically, FIG. 13 is a flowchart illustrating a specific example of the processing of step S406.

First, the identification unit 130 identifies area where the vehicle M is located before movement to the overlap area (step S500). Subsequently, the control unit 140 determines whether the vehicle M is located in the 1st-1 area AR11 before movement to the overlap area (step S502). When the vehicle M is located in the 1st-1 area AR11 before the movement to the overlap area (YES in step S502), the processing proceeds to step S504. The processing of step S504 is processing in the 1st-1 area AR11 similar to the processing described in FIG. 7.

When the vehicle M is not located in the 1st-1 area AR11 before the movement to the overlap area (NO in step S502), the control unit 140 determines whether the vehicle M is located in the 1st-2 area AR12 before the movement to the overlap area (step S506). When the vehicle M is located in the 1st-2 area AR12 before the movement to the overlap area (YES in step S506), the processing proceeds to step S508. The processing of step S508 is processing in the 1st-2 area AR12 similar to the processing described in FIG. 8.

When the vehicle M is not located in the 1st-2 area AR12 before the movement to the overlap area (NO in step S506), the processing proceeds to step S510. The processing of step S510 is processing in the 1st-3 area AR13 similar to the processing described in FIG. 9. After the processing of step S504 ends, after the processing of step S508 ends, or after the processing of step S510 ends, the driving assistance device 100 ends the processing illustrated in FIG. 13.

In this way, by executing the vehicle control by prioritizing the standard corresponding to the area where the vehicle M is located before the movement to the first overlap area ARA or the second overlap area ARB, it is possible to inhibit restriction on the start or continuity of excessive vehicle control. For example, when vehicle enters the overlap area from a non-overlap area before the movement and then immediately returns to the non-overlap area before the movement, a state of the non-overlap area before the movement can be maintained, and thus convenience of a user is improved.

Different restrictions are imposed on the vehicle control in each area included in the first area AR1, as described above. However, when the control information in the first area AR1 acquired by the second acquisition unit 160 is the same as the control information in the second area AR2, the control unit 140 may execute the vehicle control without imposing the restrictions in each area included in the first area AR1. That is, when the suppliable vehicle control is the same between the first area AR1 and the second area AR2, the control unit 140 may execute the vehicle control without imposing the restriction. For example, even when the vehicle M is located in the 1st-1 area AR11 and the vehicle control is newly requested, the control unit 140 may start the vehicle control.

In this way, when the suppliable vehicle control is the same between adjacent areas, the vehicle control can be inhibited from being restricted excessively by imposing restrictions on the vehicle control. Specifically, when the supplied vehicle control is not the same between the first area AR1 and the second area AR2, safety of the vehicle M and an occupant of the vehicle M is likely not to be maintained because the same vehicle control is executed. Therefore, the restrictions are imposed on the vehicle control. However, when the suppliable vehicle control is the same between the first area AR1 and the second area AR2, the same vehicle control can be executed. Therefore, not by imposing no restrictions on the vehicle control but by inhibiting restrictions from being excessively imposed on the vehicle control, it is possible to improve convenience of the driver.

The above-described form can be expressed as follows.

A vehicle control device including:
a storage device that stores a program; and
a hardware processor,
wherein the hardware processor executes the program stored in the storage device to:
   acquire positional information of a vehicle; and
   execute vehicle control, the vehicle control being automated driving or driving assistance of the vehicle,
   wherein there are a 1st area and a 2nd area adjacent to the 1st area,
   wherein the 2nd area is different the suppliable vehicle control from in the 1st area,
   wherein the 1st area includes a 1st-1 area, a 1st-2 area, and a 1st-3 area,
   wherein the 1st-1 area is an area adjacent to the 1st-2 area and a first boundary, the first boundary being a boundary line between the 1st and 2nd areas,
   wherein the 1st-2 area is an area adjacent to the 1st-1 and 1st-3 areas, wherein the 1st-3 area is an area adjacent to the 1st-2 area and not adjacent to the 1st-1 area and the boundary line, and
   wherein the hardware processor executes the program stored in the storage device to:
      identify whether the vehicle is located in one of the 1st-1, 1st-2, and 1st-3 areas based on the positional information;
      prevent the vehicle control when the vehicle is located in the 1st-1 area;
      prohibit start of the vehicle control when the vehicle is located in the 1st-2 area; and
      execute the vehicle control when the vehicle is located in the 1st-3 area.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a storage medium configured to store computer-readable instructions; and
one or more processors connected to the storage medium,
wherein the one or more processors execute the computer-readable instructions to:
acquire positional information of a vehicle; and
execute vehicle control, the vehicle control being automated driving or driving assistance of the vehicle,
wherein there are a 1st area and a 2nd area adjacent to the 1st area,
wherein the 2nd area is different the suppliable vehicle control from in the 1st area,
wherein the 1st area includes a 1st-1 area, a 1st-2 area, and a 1st-3 area,
wherein the 1st-1 area is an area adjacent to the 1st-2 area and a first boundary, the first boundary being a boundary line between the 1st and 2nd areas,
wherein the 1st-2 area is an area adjacent to the 1st-1 and 1st-3 areas,
wherein the 1st-3 area is an area adjacent to the 1st-2 area and not adjacent to the 1st-1 area and the boundary line, and
wherein the one or more processors is configured to:
identify whether the vehicle is located in one of the 1st-1, 1st-2, and 1st-3 areas based on the positional information;
prevent the vehicle control
when the vehicle is located in the 1st-1 area;
prohibit start of the vehicle control
when the vehicle is located in the 1st-2 area; and
execute the vehicle control
when the vehicle is located in the 1st-3 area.

2. The vehicle control device according to claim 1, further comprising: wherein the one or more processors execute the computer-readable instructions to:
recognize surrounding information, the surrounding information being information regarding surroundings of the vehicle; and
change a range of an area by changing at least one of boundaries between the 1st-1, 1st-2, and 1st-3 areas based on the surrounding information.

3. The vehicle control device according to claim 2, wherein
the 1st-2 area is an area adjacent to the 1st-1 area without overlapping, and the 1st-3 area is an area adjacent to the 1st-2 area without overlapping, wherein
the one or more processors execute the computer-readable instructions to
control execution, start, or continuation of the vehicle control in accordance with movement of a vehicle between areas.

4. The vehicle control device according to claim 2, wherein
a part of the 1st-1 area overlaps a part of the 1st-2 area, and a part of the 1st-2 area overlaps a part of the 1st-3 area, wherein
the one or more processors execute the computer-readable instructions to
control execution, start, or continuation of the vehicle control in accordance with movement of a vehicle between areas.

5. The vehicle control device according to claim 4, wherein
the one or more processors execute the computer-readable instructions to:
prevent the vehicle control by prioritizing a standard corresponding to the 1st-1 area
when the vehicle is located in a first overlapping area, the first overlapping area being an area overlapping the 1st-1 and 1st-2 areas; and
prohibit start of the vehicle control by prioritizing a standard corresponding to the 1st-2 area
when the vehicle is located in a second overlapping area, the second overlapping area being an area overlapping the 1st-2 and 1st-3 areas.

6. The vehicle control device according to claim 4, wherein
the one or more processors execute the computer-readable instructions to
execute the vehicle control by prioritizing a standard corresponding to an area located the vehicle before movement of the vehicle to the first or second overlapping area
when the vehicle is located in a first overlapping area or a second overlapping area, the first overlapping area overlapping the 1st-1 and 1st-2 areas, the second overlapping area overlapping the 1st-2 and 1st-3 areas.

7. The vehicle control device according to claim 1, wherein
the one or more processors execute the computer-readable instructions to:
acquire control information regarding the suppliable vehicle control in the first and second areas; and
execute the vehicle control without imposing restriction on control of the vehicle control
when control information of the first area is identical with control information of the second area and
when the vehicle is located in the 1st-1, 1st-2, or 1st-3 area.

8. A vehicle control method comprising:
acquiring positional information of a vehicle; and
executing vehicle control, the vehicle control being automated driving or driving assistance of the vehicle,
wherein there are a 1st area and a 2nd area adjacent to the 1st area,
wherein the 2nd area is different the suppliable vehicle control from in the 1st area,
wherein the 1st area includes a 1st-1 area, a 1st-2 area, and a 1st-3 area,
wherein the 1st-1 area is an area adjacent to the 1st-2 area and a first boundary, the first boundary being a boundary line between the 1st and 2nd areas,
wherein the 1st-2 area is an area adjacent to the 1st-1 and 1st-3 areas,
wherein the 1st-3 area is an area adjacent to the 1st-2 area and not adjacent to the 1st-1 area and the boundary line, and
wherein the vehicle control method causing a computer to execute:
identifying whether the vehicle is located in one of the 1st-1, 1st-2, and 1st-3 areas based on the positional information;
preventing the vehicle control
when the vehicle is located in the 1st-1 area;
prohibiting start of the vehicle control
when the vehicle is located in the 1st-2 area; and
executing the vehicle control
when the vehicle is located in the 1st-3 area.

9. A non-transitory storage medium having a program stored therein, the program causing a computer to:
acquire positional information of a vehicle; and
execute vehicle control, the vehicle control being automated driving or driving assistance of the vehicle,
wherein there are a 1st area and a 2nd area adjacent to the 1st area,
wherein the 2nd area is different the suppliable vehicle control from in the 1st area,
wherein the 1st area includes a 1st-1 area, a 1st-2 area, and a 1st-3 area,
wherein the 1st-1 area is an area adjacent to the 1st-2 area and a first boundary, the first boundary being a boundary line between the 1st and 2nd areas,
wherein the 1st-2 area is an area adjacent to the 1st-1 and 1st-3 areas,
wherein the 1st-3 area is an area adjacent to the 1st-2 area and not adjacent to the 1st-1 area and the boundary line, and
wherein the program causing the computer to:
identify whether the vehicle is located in one of the 1st-1, 1st-2, and 1st-3 areas based on the positional information;
prevent the vehicle control
when the vehicle is located in the 1st-1 area;
prohibit start of the vehicle control
when the vehicle is located in the 1st-2 area; and
execute the vehicle control
when the vehicle is located in the 1st-3 area.
